(19) United States
(12) Patent Application Publication
(10) Pub. No.: US 2020/0198545 A1
(43) Pub. Date: Jun. 25, 2020

(54) END GATE STORAGE COMPARTMENT

(71) Applicant: GM Global Technology Operations LLC, Detroit, MI (US)

(72) Inventors: James M. Townson, Clarkston, MI (US); Anil A. Masih, Royal Oak, MI (US); Manuel J. Martinez, Clinton Township, MI (US); Dusan Colovic, Troy, MI (US); Robert A. Greene, Roseville, MI (US); Spencer T. Seufert, St. Clair Shores, MI (US); Mark Pulleyblank, Harrison Township, MI (US)

(21) Appl. No.: 16/225,431

(22) Filed: Dec. 19, 2018

(51) Int. Cl. B60R 9/06; B60R 5/04; B62D 33/027

(52) U.S. Cl. CPC B60R 9/065; B62D 33/0273; B60R 5/04

(57) ABSTRACT

An end gate includes a first panel. The end gate also has a first side and a second side. The end gate also includes an opening defined by the first panel between the first side and the second side. The end gate further includes a basket including a basket base and at least two ribs extending from the basket base and affixed to the first panel, wherein the basket base and at least two ribs define a volume accessible from the opening.

### INTRODUCTION

In-cab storage provides a place to store items within pick-up trucks; such spaces may include center consoles, glove compartments and under-seat storage. However, pick-up trucks often lack secure storage outside of the cab conveniently accessible for storing tools, gloves tow ball inserts, jacks, lug wrenches, tie-down straps, chains lug wrenches, jumper cables, or other items. To provide secure storage places, bed mounted tool boxes may be utilized. In addition, various end gate storage solutions providing storage within the free-volume of an end gate have also been employed.

However, storages solutions that take up volume in the pick-up box bed may interfere with storing other items in the pick-up box bed. In addition, the storage solutions noted above may utilize latching mechanisms located within the storage compartment and may become jammed by items within the storage compartment. Also, when not concealed, the locks or latches may lack a desirable level of security. It may further be desirable to provide additional integrated accessories that do not take up any volume, or take up very little volume, in the pick-up box bed.

Thus, while current storage compartments achieve their intended purpose, there is a need for a new and improved system and method for providing exterior storage compartments.

### SUMMARY

According to several aspects, an end gate includes a first panel. The end gate also includes a first side and a second side. In addition, the end gate includes an opening defined by the first panel between the first side and the second side. The end gate further includes a basket including a basket base and at least two ribs extending from the basket base and affixed to the first panel. The basket base and at least two ribs define a volume accessible from the opening.

In an additional aspect of the present disclosure, the end gate further includes a storage compartment positioned within the basket volume. The storage compartment includes a flange that rests on a surface of the first panel. A storage compartment lid is configured to cover the storage compartment and the opening in the first panel.

In another aspect of the present disclosure, the storage compartment lid is affixed to the flange by a hinge.

In another aspect of the disclosure, the end gate includes a latching mechanism configured to engage the storage compartment lid. The latching mechanism includes at least one latch actuator affixed to at one of the first side of the end gate and the second side of the end gate.

In another aspect of the present disclosure, the storage compartment lid is affixed to the surface of the first panel by a hinge.

In another aspect of the present disclosure, the end gate further includes a secondary lid disposed over the storage compartment lid.

In another aspect of the present disclosure, the secondary lid is a bench back.

In another aspect of the present disclosure, the secondary lid is attached to the first surface by a hinge.

In another aspect of the present disclosure, the secondary lid is attached to the storage compartment lid by a hinge.

In another aspect of the present disclosure, the compartment lid includes a secondary lid latch configured to engage the secondary lid.

In another aspect of the present disclosure, the end gate further includes a debris shield, wherein the debris shield is affixed to the surface of the first panel by a hinge.

In another aspect of the present disclosure, the end gate further includes a close-out panel affixed to the first panel, wherein the close-out panel covers the opening in the first panel.

According to several aspects, an end gate includes a first panel and a second panel, the end gate having a first side and a second side. The end gate also includes a cavity defined by the first panel and the second panel as well as an opening defined by the first panel between the first side and the second side providing access to the cavity. The end gate further includes a basket located in the cavity. The basket includes a basket base and at least two ribs extending from the basket base and affixed to the first panel. The end gate yet further includes a storage compartment positioned within the basket. The storage compartment includes a flange that rests on a surface of the first panel surrounding at least a portion of the opening. In addition, the end gate includes a storage compartment lid configured to cover the storage compartment and the opening in the first panel. The end gate also includes a secondary lid disposed on the storage compartment lid in a first, closed position.

In an additional aspect of the present disclosure, the storage compartment lid rotates around a first axis.

In another aspect of the present disclosure, the end gate includes a debris shield affixed to the first panel by a hinge, wherein the debris shield is rotatable around a second axis parallel to the first axis.

In another aspect of the present disclosure, the secondary lid is attached to the storage compartment lid by a hinge.

In another aspect of the present disclosure, the secondary lid is rotatable around the same axis as the storage compartment lid.

In another aspect of the disclosure, the compartment lid includes a secondary lid latch configured to engage the secondary lid.

In another aspect of the disclosure, the end gate includes a latching mechanism configured to engage the storage compartment lid. The latching mechanism includes at least one latch actuator affixed to at one of the first side of the end gate and the second side of the end gate.

According to several aspects, a pick-up bed box includes an end gate affixed to the pick-up box bed. The end gate includes a first panel and a second panel. The end gate also has a first side and a second side. The end gate further includes a cavity defined by the first panel and the second panel as well as an opening defined by the first panel between the first side and the second side providing access to the cavity. In addition, the end gate includes a basket located in the cavity. The basket includes a basket base and at least two ribs extending from the basket base and affixed to the first panel. The end gate further includes a storage compartment positioned within the basket. The storage compartment includes a flange that rests on a surface of the first panel surrounding at least a portion of the opening. The end gate yet further includes a storage compartment lid configured to cover the storage compartment and the opening in the first panel. The end gate also includes a debris shield affixed to the first panel by a hinge, wherein an end of the debris shield rests on the pick-up box bed.

In another aspect of the disclosure, the end gate of the pick-up box bed includes a latching mechanism configured to engage the storage compartment lid. The latching mechanism includes at least one latch actuator affixed to at one of the first side of the end gate and the second side of the end gate.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of a first panel of an end gate including an opening in the panel according to an exemplary embodiment;

FIG. 2 is a perspective view of a first panel of an end gate including a close-out sealing the opening according to an exemplary embodiment;

FIG. 3 is a perspective view of a basket attached to a first panel of an end gate, which is positioned in a first, closed position relative to the pick-up box bed according to an exemplary embodiment;

FIG. 4 is a perspective view of an assembled end gate including a storage compartment inserted into an opening in a first panel according to an exemplary embodiment;

FIG. 5 is a perspective view of a storage compartment lid affixed to a storage compartment, wherein the storage compartment lid and end gate are shown in an open position, according to an exemplary embodiment;

FIG. 6 is a perspective view of a storage compartment lid affixed to a storage compartment, wherein the storage compartment lid and end gate are shown in closed position, according to an exemplary embodiment;

FIG. 7 is a perspective view of a debris shield affixed to the end gate according to an exemplary embodiment;

FIG. 8 is a cross-sectional view of an end gate including a storage compartment, storage compartment lid, and debris shield, wherein the end gate and the storage compartment lid are in a closed position according to an exemplary embodiment;

FIG. 9 is a cross-sectional view of an end gate including a storage compartment, storage compartment lid, and debris shield, wherein the end gate and the storage compartment lid are in an open position according to an exemplary embodiment;

FIG. 10 illustrates a perspective view of an end gate including a storage compartment and a bench accessory mounted on the storage compartment lid according to an exemplary embodiment;

FIG. 11 illustrates a perspective view of an end gate including a storage compartment and a bench accessory mounted on the storage compartment lid wherein the storage compartment lid is in an open position, providing access to the bench latch according to an exemplary embodiment;

FIG. 12 illustrates a perspective view of a latch release button actuator for the storage compartment, the actuator is affixed to a side of the end gate according to an exemplary embodiment;

FIG. 13 illustrates a perspective view of a latch release lever actuator for the storage compartment, the actuator is affixed to a side of the end gate according to an exemplary embodiment; and

FIG. 14 illustrates a method of providing a storage compartment and, optionally, other accessories according to an exemplary embodiment.

### DETAILED DESCRIPTION

The following description is merely exemplary in nature and is not intended to limit the present disclosure, application, or uses.

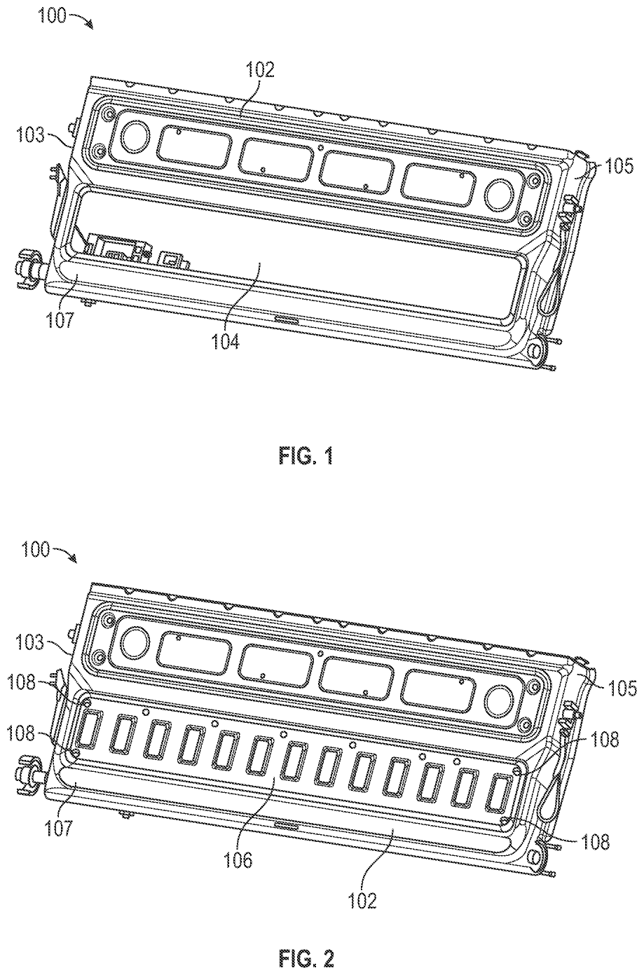

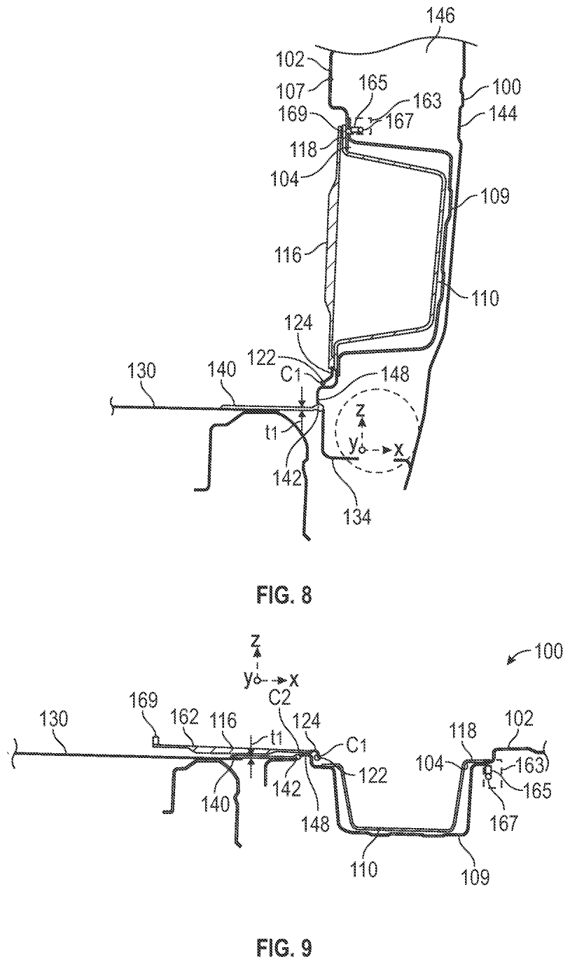

Referring to FIG. 1, which illustrates an aspect of the present disclosure, a first panel 102 of an end gate 100 is illustrated including an opening 104 defined in the first panel 102 between a first side 103 and a second side 105 of the end gate 100. As illustrated, the sides 103, 105 are provided by the first panel 102; however, one or more additional panels may be used to provide the sides 103, 105. Further, it may be appreciated that a surface 107 of the first panel 102 faces, and is internal to, the pick-up box bed 130 as later illustrated in FIG. 8.

In aspects, the opening 104 is formed and defined in the first panel 102 when the first panel 102 is formed by, for example, stamping or a trimming process. In alternative aspects, the opening 104 may be formed and defined in the first panel 102 after assembly through a post process, such as by a trimming process. Trimming processes may include, but are not limited to, laser trimming, plasma cutting, or machining. It should be appreciated, however, that forming the opening 104 prior to assembly may reduce waste, time, and cost.

The incorporation of the opening 104 in the end gate 100 provides an end gate design that allows for the optional, pre-sale or post-sale upscaling of the vehicle through the installation of an accessory feature including a storage compartment as well as additional, or alternative, optional accessories, described further herein. Upscaling may be understood herein as the upgrading of a vehicle with various accessories. With reference to FIG. 2, a close-out panel 106 may be fastened to the opening 104 with one or more mechanical fasteners 108 to seal the opening 104 closed. The close-out panel 106 is then removed should an optional feature be selected. In an aspect, the close-out panel 106 may be formed from stamped steel; alternatively, the close-out panel 106 may be formed of other materials, such as metal or a polymer material.

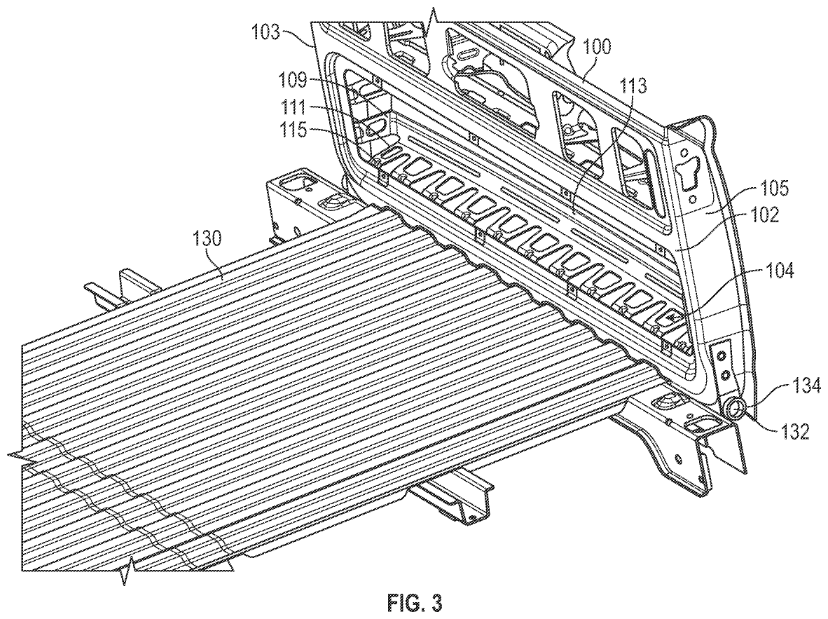

FIG. 3 illustrates an aspect, without the close-out panel 106 installed, including a basket 109 affixed to the first panel 102 around the opening 104. The basket 109 may be used to locate accessories in the end gate 100 and assist accessory installation. As illustrated, the basket 109 includes a number of ribs 111, that is, at least two ribs 111 and up to 50 ribs, extending from a basket base 113. The ribs 111 support the basket base 113 and are attached to the first panel 102 by, for example, mechanical fasteners or welds 115. The ribs 111 and the basket base 113 define a volume V, which is accessible from the opening 104 in the first panel 102.

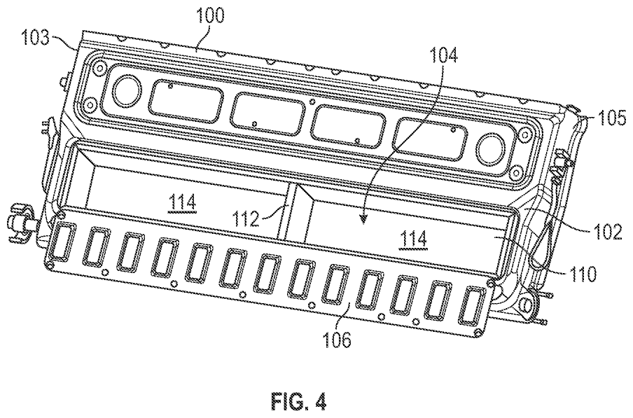

Referring now to FIG. 4, an aspect is illustrated wherein the close-out panel 106 is removed and a storage compartment 110 is positioned within the opening 104 defined in the first panel 102 of the end gate 100. The storage compartment 110 is illustrated as including a divider 112 to separate the storage compartment 110 into two bins 114; however, other configurations of the storage compartment 110 may be employed.

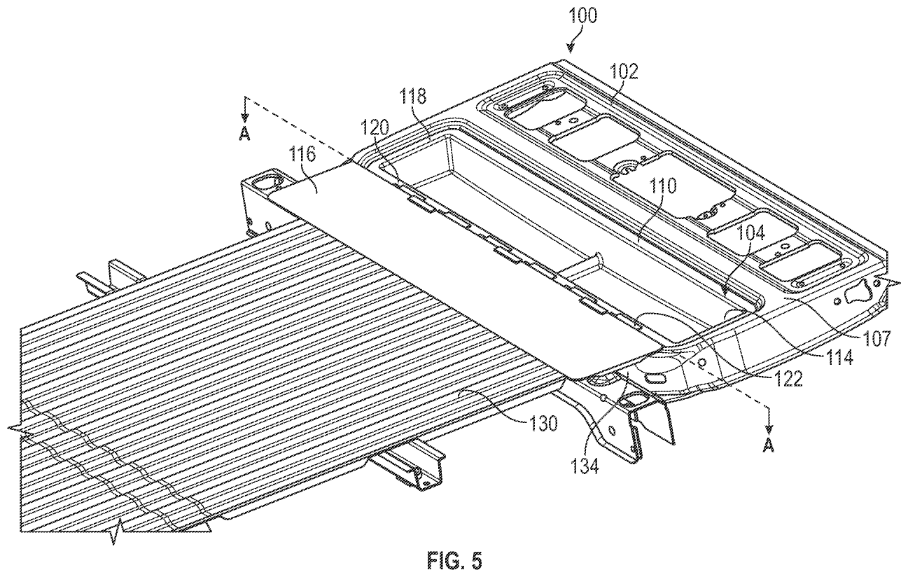

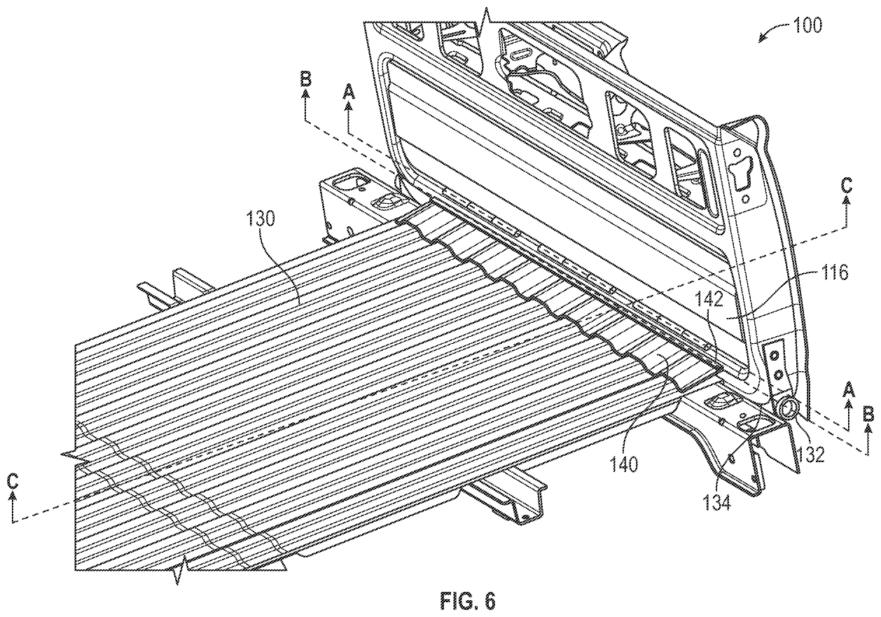

FIG. 5 illustrates an aspect including the storage compartment 110 placed in the opening 104 with a storage compartment lid 116. The storage compartment lid 116 is configured to cover the storage compartment 110 and the opening 104 in the first panel 102. In the illustrated aspect, the storage compartment 110 includes a flange 118 that rests on the surface 107 of the first panel 102. The flange 118 surrounds at least a portion of the opening 104 up to the entire opening. One side 120 of the flange 118 includes a hinge 122, which may either be attached to the side 120 of the flange 118 or to the first panel 102. The hinge 122 is also attached to the storage compartment lid 116, which is movable between a first position to a second position around a first axis A-A. The hinge 122 provides rotation, around the first axis A-A, of the compartment lid 116 from the first, closed position (see FIG. 6) to the second open position. The hinge 122 may include, for example, a spring hinge, a barrel hinge, a piano hinge, or multi-bar linkages.

FIGS. 3 and 5 illustrate an aspect of the end gate 100 placed relative to the pick-up box bed 130 as it would appear assembled but with the side walls (not illustrated) removed. FIG. 3 illustrates the end gate 100 in a first, closed position and FIG. 5 illustrates the end gate 100 in a second, open position. As shown in FIG. 3, the end gate 100 is affixed to the pick-up box bed 130 proximal to the end gate base 134 using a side-mounted end gate hinge 132, half of which is seen on the side of the end gate 100 in FIG. 3. The end gate hinge 132 may alternatively include, for example, piano hinges, spring hinges or multi-arm linkages.

FIG. 6 illustrates an aspect of the end gate 100 where the storage compartment lid 116 is in the closed position, covering the opening 104. In this aspect, an additional accessory, a debris shield 140, is illustrated. At one end, the debris shield 140 is attached to the end gate 100. At the other end, the debris shield 140 rests on the pick-up box bed 130. The debris shield 140 keeps debris from falling between the end gate 100 and the pick-up box bed 130, spanning any gap between the end gate 100 and the pick-up box bed 130.

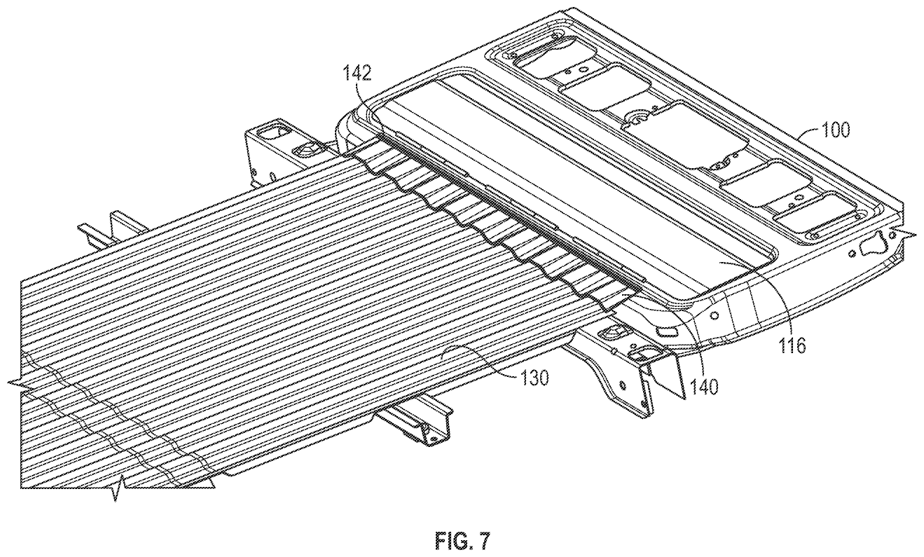

In aspects, the debris shield 140 is movable around axis B-B between a first position when the end gate 100 is closed, as illustrated, to a second position when the end gate 100 is open, seen in FIG. 7. In aspects, the debris shield 140 is attached to the end gate 100 via a hinge 142, which may include, for example a spring hinge, a barrel hinge, or a piano hinge. In aspects, the weight of the debris shield 140 keeps the debris shield 140 resting against the pick-up box bed 130. In alternative aspects, the debris shield 140 may be biased against the pick-up box bed 130, by a spring, or the debris shield hinge 142.

As noted above and illustrated in FIGS. 6 and 7, the debris shield 140 rotates around a second axis, B-B, which is parallel to the first axis A-A. However, it may be appreciated, that the compartment lid hinge(s) 122 and the debris shield hinge(s) 142 may be arranged such that axis B-B may be coincident to the first axis A-A; that is, axes A-A and B-B may be the same.

FIGS. 8 and 9 illustrate an aspect of a cross-section C-C of the end gate 100 illustrated in FIG. 6. In addition to the first panel 102, FIG. 8 illustrates a second panel 144 and a cavity 146 defined by the first panel 102 and the second panel 144. The opening 104 provides access to the cavity 146. In an aspect, the second panel 144 provides the exterior surface of the end gate 100. Further, the surface 107 of the first panel 102 opposes the cavity 146.

The basket 109 is illustrated positioned between the first and second panels 102, 144 in the cavity 146. In addition, a storage compartment 110 is illustrated as being received in the opening 104 defined by the first panel 102. The flange 118 of the storage compartment 110 rests adjacent to the first panel 102. In this aspect, the compartment lid 116 is illustrated in a first, closed position, fixed to the first panel 102 by hinge 122 in FIG. 8 and is illustrated in a second, open position in FIG. 9. The compartment lid 116 is rotatable around center point C1 (coincident to axis A-A). In the illustrated aspect, the first panel 102 includes a ridge 148. The compartment lid hinge 122 is affixed to one side of the ridge 148 distal from the pick-up box bed 130 and the debris shield hinge 142 is provided on the other side of the ridge 148 proximal to the pick-up box bed 130.

As seen in FIGS. 8 and 9, the compartment lid hinge 122 includes an offset 124 that provides clearance of the compartment lid hinge 122 over the ridge 148 when the end gate 100 is in the open position, preventing rotation of the compartment lid 116 being impinged by the ridge 148 or debris shield 140. The offset 124 spaces the compartment lid 116 in both the vertical and horizontal planes (see references Z and X, respectively, in the figure) relative to the pick-up box bed 130. In the illustrated aspect, the center point C2 (coincident with axis B-B) of the debris shield hinge 142 is spaced in the vertical plane (Z) at least half the thickness of the debris shield 140. However, in other aspects, the spacing may be at least the thickness t1 or greater than the thickness t1 of the debris shield 140, such as double the thickness t1, or three times the thickness t1 of the debris shield 140.

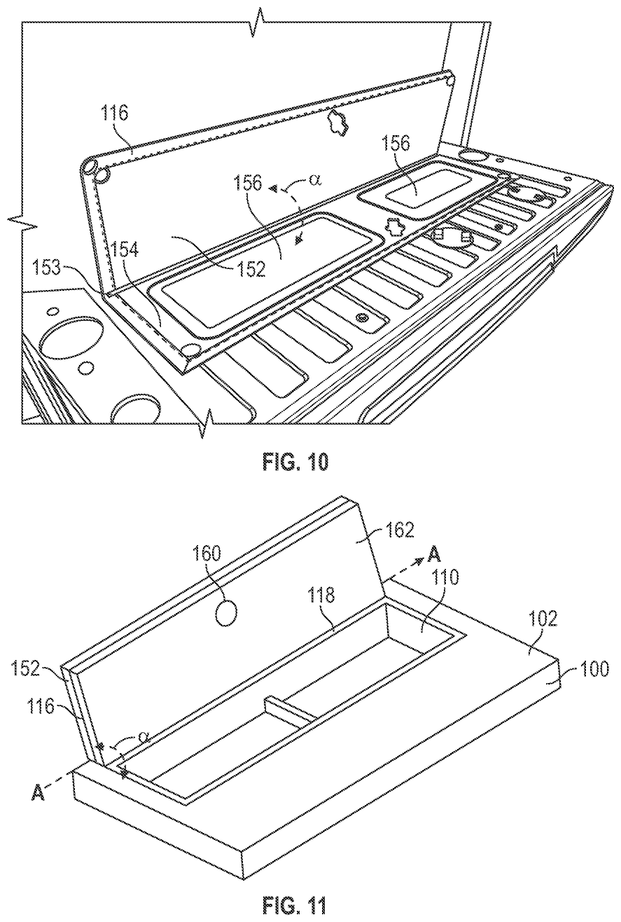

Referring to FIGS. 10 and 11, these figures illustrate an aspect where an accessory, in addition to the storage compartment 110, is provided. In an aspect, the storage compartment lid 116 includes a secondary lid 152, which is disposed on the storage compartment lid 116 in a first, closed position, and is rotatable at an angle alpha (from 0 degrees in the closed position to 180 degrees in the fully opened position, including all values and ranges therein, such as 90 degrees, 120 degrees, etc.) to provide a bench back. In this aspect, the storage compartment lid 116 provides a seat surface. The surface 154 of the storage compartment lid 116 may also include cushions 156 or cup holders (not illustrated).

In the illustrated aspect, the secondary lid 152 is attached to the storage compartment lid 116 by a hinge 153. The hinge 153 may, for example, share an axis with the storage compartment lid hinge 122 axis A-A, as illustrated. Alternatively, the secondary lid 152 may be attached to the compartment lid and rotate around an axis offset, but parallel to, the storage compartment lid hinge 122. In further alternative embodiments, the secondary lid 152 may be attached to the first panel 102, in a manner similar to the debris shield 140.

In aspects, the secondary lid 152 is retained in a closed position against the storage compartment lid 116 with at least one latch 160. The secondary lid latch 160 is configured to engage the secondary lid 152, so that the storage compartment lid 116 may be opened without opening the secondary lid 152. In examples, the secondary lid latch 160 may include a mechanical fastener that includes a first portion affixed to the compartment lid 116 and a second portion, engaged by or that engages the first portion, affixed to the secondary lid 152 or a feature formed in the secondary lid 152. The latch may include, but is not limited to, a turn latch or a sliding latch. In aspects, the secondary lid latch 160 may be accessed from the interior side 162 of the compartment lid 116 facing the storage compartment 110 (see FIG. 11).

In aspects, alternative accessories may be provided. For example, instead of a seat bench, a separate, secondary compartment from the storage compartment 110 may be defined by the storage compartment lid 116 and the secondary lid 152. The secondary compartment may be large enough to accommodate utility items or personal items and instead of seat cushions 156, storage bins, or foam, for example, maybe provided to protect the items stored in the secondary compartment. In a further alternative aspect, the secondary lid 152 may provide features such as an expandable tailgate work surface. In yet further aspects, the storage compartment 110 itself may be configured as, for example, an ice chest, a tackle box, or a tool chest. In yet further aspects, the storage compartment 110 may also include, for example, an expandable end gate work surface.

In addition, in aspects, the storage compartment 110 is removable for portability and cleaning purposes. It may be appreciated that by fixing the storage compartment lid 116 to the storage compartment 110, the two pieces may be removed together, providing a stand-alone storage system. Where the storage compartment 110 includes a bench accessory, the storage compartment 110 may be removed to provide a stand-alone bench. In such aspects, bench legs may be provided which extend from the bottom of the storage compartment. In aspects where the storage compartment 110 includes a fold-out work table, the storage compartment 110 may be removed to provide a stand-alone table. In such aspects, folding table legs may be provided and may extend from the bottom of the storage compartment 110.

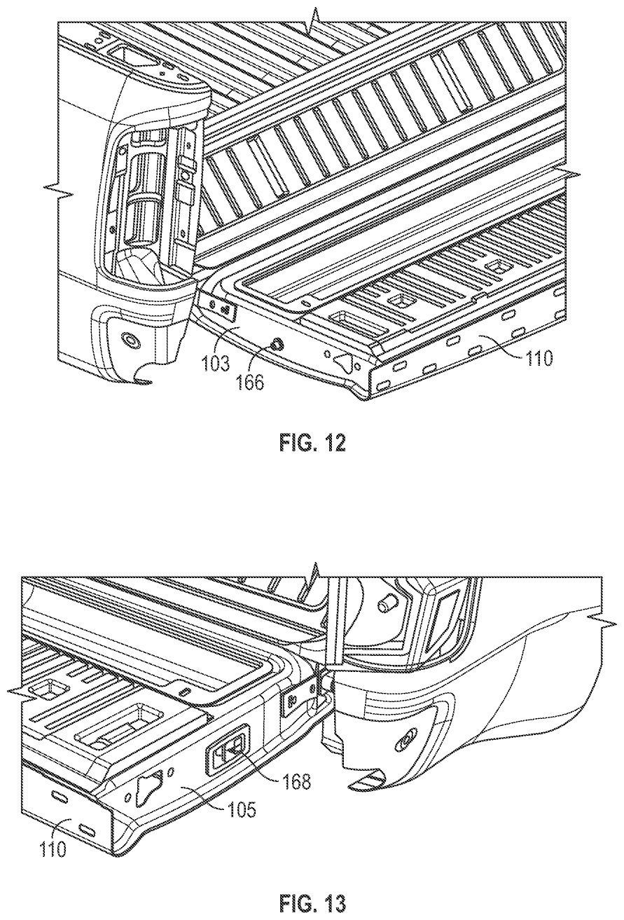

In aspects, the storage compartment 110 may be retained in a closed position utilizing a latching mechanism 163 accessible from either or both sides 103, 105 of the end gate 100. As illustrated in FIGS. 8 and 9, the latching mechanism 163 is configured to engage a striker 169 extending from the storage compartment lid 116 with a latch 165. The latching mechanism 163 also includes at least one latch release actuator (166, 168 illustrated in FIGS. 12 and 13) and an actuator rod 167 extending from the latch actuator to the latch 165.

Reference is made to FIG. 12 illustrating an aspect including latch release button actuator 166 positioned at the side 103 of the end gate 100 and FIG. 13 illustrating an aspect including a latch release lever actuator 168 positioned at the opposing side 105 of the end gate 100. It should be appreciated that, in aspects, one or both of the actuators 166, 168 are present at the sides 103, 105 of the end gate depending on the design of the latching mechanism 163. It should further be appreciated that when the end gate 100 is closed the sides 103, 105 of the end gate 100 are concealed, concealing the latch release actuators 166, 168. It should be appreciated that when the end gate 100 is in the closed position, the latch release actuators 166, 168 positioned at the end gate sides 103,105 are not accessible, particularly when the end gate 100 is locked. In aspects, the latch release actuators 166, 168 are also lockable, so that even if the end gate 100 is in the open position, the latch release actuators 166, 168 cannot be activated. Further, in aspects, locking of the storage compartment 110 may be integrated with other tailgate locking functions. An example of a latching mechanism 163 for an end gate 100 is described in U.S. application Ser. No. 16/225,398, filed on Dec. 19, 2018, entitled “Tailgate Storage Compartment”, the teachings of which are incorporated herein by reference.

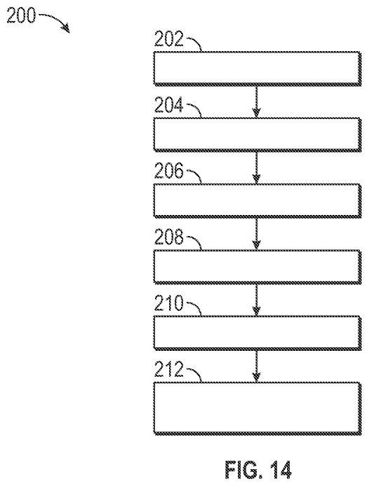

FIG. 14 illustrates an aspect of a method for providing an end gate with a storage compartment. The method 200 includes providing an opening in a first panel of an end gate 202. It may be appreciated that this may be completed prior to assembling the end gate to the pick-up box bed and in aspects prior to assembling the first and second end gate panels together. The method further includes affixing a basket to the first panel of the end gate 204. A close-out panel is then attached to seal the opening in the first panel 206. If not already assembled, the end gate may then be assembled and affixed to the vehicle 208. If the option of placing a storage compartment in the end gate is elected, the close-out panel is then removed 210 and the storage compartment and any additional accessories, such as a debris shield or secondary accessories are then affixed to the end gate 212.

It may be appreciated that while the end gate 100 is illustrated as pivoting from the base 134 of the end gate 100, an end gate 100 according to the above aspects may also pivot from one of the sides 103, 105 of the end gate 100. Further, while the end gate 100 is illustrated as being affixed to a pick-up box bed 130, the end gate 100 may be affixed to other alternative types of vehicles.

An end gate storage compartment 110 of the present disclosure offers several advantages. These advantages may include, for example, the preparation of an end gate for later upscaling of the vehicle to include a storage compartment and optionally other accessories. These advantages may also include, for example, a bin lid system that may be layered to include integral closeout for debris and dust intrusion, modifiable for position and use as a backrest for tailgating, or flappable for an expanded end gate work surface. These advantages may further include, for example, bins that may be compartmentalized to accommodate customer preference, removable for portability and cleaning, integrated for structural performance, damage control and corrosion control. These advantages may further include, for example, an end gate storage compartment, which may be and may further be integrated with the end gate locking body functions.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An end gate, comprising:
an end gate including a first panel, the end gate having a first side and a second side;
an opening defined by the first panel between the first side and the second side; and
a basket including a basket base and at least two ribs extending from the basket base and affixed to the first panel, wherein the basket base and at least two ribs define a volume accessible from the opening.

2. The end gate of claim 1, further comprising
a storage compartment positioned within the basket volume, the storage compartment includes a flange that rests on a surface of the first panel, and
a storage compartment lid configured to cover the storage compartment.

3. The end gate of claim 2, wherein the storage compartment lid is affixed to the flange by a hinge.

4. The end gate of claim 2, further including a latching mechanism configured to engage the storage compartment lid, wherein the latching mechanism includes at least one latch actuator affixed to at least one of the first side of the end gate and the second side of the end gate.

5. The end gate of claim 2, wherein the storage compartment lid is affixed to the surface of the first panel by a hinge.

6. The end gate of claim 2, further including a secondary lid disposed over the storage compartment lid.

7. The end gate of claim 6, wherein the secondary lid is a bench back.

8. The end gate of claim 6, wherein the secondary lid is attached to the storage compartment lid by a hinge.

9. The end gate of claim 6, wherein the compartment lid includes a secondary lid latch configured to engage the secondary lid.

10. The end gate of claim 1, further including a debris shield, wherein the debris shield is affixed to a surface of the first panel by a hinge.

11. The end gate of claim 1, further including a close-out panel affixed to the first panel, wherein a close-out panel covers the opening in the first panel.

12. An end gate, comprising:
an end gate including a first panel and a second panel, the end gate having a first side and a second side;
a cavity defined by the first panel and the second panel;
an opening defined by the first panel between the first side and the second side providing access to the cavity;
a basket located in the cavity, the basket including a basket base and at least two ribs extending from the basket base and affixed to the first panel;
a storage compartment positioned within the basket, the storage compartment including a flange that rests on a surface of the first panel surrounding at least a portion of the opening,
a storage compartment lid configured to cover the storage compartment and the opening in the first panel; and
a secondary lid disposed on the storage compartment lid in a first, closed position.

13. The end gate of claim 12, wherein the storage compartment lid rotates around a first axis.

14. The end gate of claim 13, further including a debris shield affixed to the first panel by a hinge, wherein the debris shield is rotatable around a second axis parallel to the first axis.

15. The end gate of claim 13, wherein the secondary lid is attached to the storage compartment lid by a hinge.

16. The end gate of claim 15, wherein the secondary lid is rotatable around the same axis as the storage compartment lid.

17. The end gate of claim 12, wherein the compartment lid includes a secondary lid latch configured to engage the secondary lid.

18. The end gate of claim 12, further including a latching mechanism configured to engage the storage compartment lid, wherein the latching mechanism includes at least one latch actuator affixed to at least one of the first side of the end gate and the second side of the end gate.

19. A pick-up box bed, comprising:
a pick-up box bed;
an end gate affixed to the pick-up box bed, including
a first panel and a second panel, the end gate having a first side and a second side;
a cavity defined by the first panel and the second panel;
an opening defined by the first panel between the first side and the second side providing access to the cavity;
a basket located in the cavity, the basket including a basket base and at least two ribs extending from the basket base and affixed to the first panel;
a storage compartment positioned within the basket, the storage compartment including a flange that rests on a surface of the first panel surrounding at least a portion of the opening,
a storage compartment lid configured to cover the storage compartment and the opening in the first panel; and
a debris shield affixed to the first panel by a hinge, wherein an end of the debris shield rests on the pick-up box bed.

20. The pick-up box bed box of claim 19, further including a latching mechanism configured to engage the storage compartment lid, wherein the latching mechanism includes at least one latch actuator affixed to at least one of the first side of the end gate and the second side of the end gate.
